(19) United States
(12) Patent Application Publication
(10) Pub. No.: US 2008/0042332 A1
(43) Pub. Date: Feb. 21, 2008

(54) FLAT DISPLAYS

(75) Inventor: Hua Chung Tseng, Taoyuan County (TW)

Correspondence Address: QUINTERO LAW OFFICE, PC, 2210 MAIN STREET, SUITE 200, SANTA MONICA, CA, 90405, US

(73) Assignee: BENQ CORPORATION, TAOYUAN (TW)

(21) Appl. No.: 11/839,450

(22) Filed: Aug. 15, 2007

(30) Foreign Application Priority Data
Aug. 16, 2006 (TW) TW95130065

(51) Int. Cl. F16F 7/00

(52) U.S. Cl. 267/136

(57) ABSTRACT

Flat displays are provided. A flat display comprises a frame, a panel module disposed in the frame, and a shock absorber disposed between the frame and the panel module. The shock absorber comprises a first flexible component, a second flexible component and a space formed therebetween. When external force is exerted on the frame, the first flexible component, the second flexible component and the space are deformed to absorb shock and protect the panel module.

### BACKGROUND OF THE INVENTION

1. Field of the Invention

The invention relates in general to flat displays and in particular to flat displays having shock absorbers.

2. Description of the Related Art

Flat displays, such as LCDs, are important components in electronic devices. Due to fragility thereof, however, shock absorption measures are critical to prevent damage from impact and external force.

### BRIEF SUMMARY OF THE INVENTION

Flat displays are provided. A flat display comprises a frame, a panel module disposed in the frame, and a shock absorber disposed between the frame and the panel module. The shock absorber comprises a first flexible component, a second flexible component and a space formed therebetween. When an external force is exerted on the frame, the first flexible component, the second flexible component and the space are deformed to absorb shock and protect the panel module.

### BRIEF DESCRIPTION OF THE DRAWINGS

The invention can be more fully understood by reading the subsequent detailed description and examples with references made to the accompanying drawings, wherein:

FIG. 1 is an exploded diagram of a flat display;

FIG. 2 is an exploded diagram of a shock absorber; and

FIGS. 3 and 4 are perspective diagrams of the shock absorber in FIG. 2.

### DETAILED DESCRIPTION OF THE INVENTION

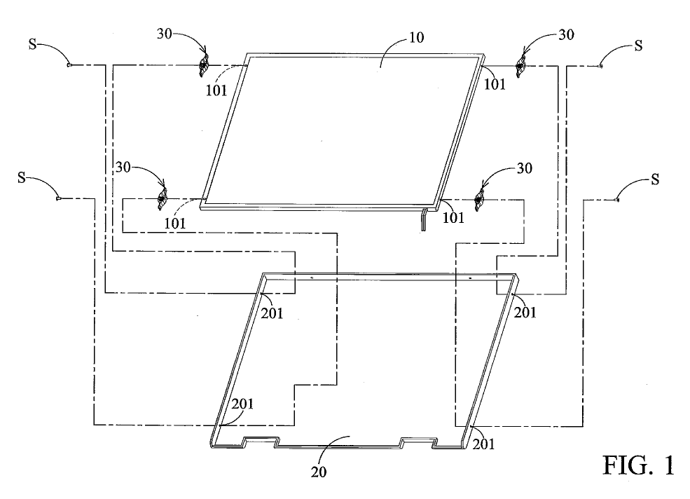

Referring to FIG. 1, an embodiment of a flat display, such as an LCD of a laptop computer, comprises a frame 20, a panel module 10 disposed in the frame 20, and at least a shock absorber 30 disposed therebetween. As shown in FIG. 1, the shock absorber 30 is joined to a recess 101 of the frame 20, and a fastener S is inserted through a hole 201 of the frame 20 to connect the shock absorber 30. Thus, the shock absorber 30 is secured between the panel module 10 and the frame 20, to absorb shock and protect the panel module 10. In some embodiments, the recess 101 can be a threaded hole, and the fastener S can be a screw corresponding thereto.

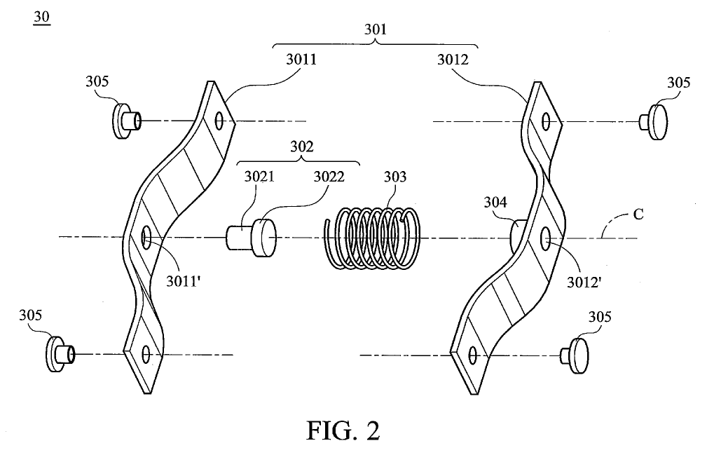

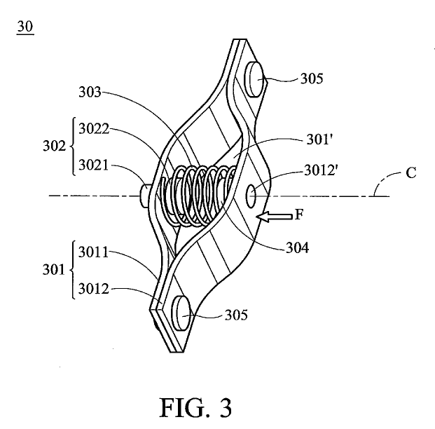

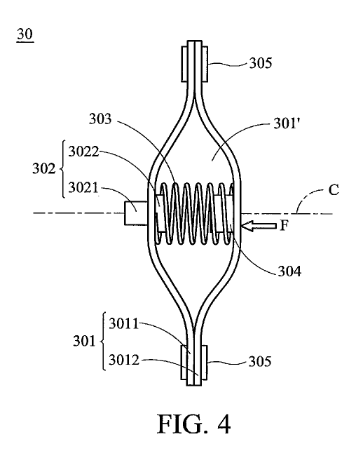

Referring to FIGS. 2-4, the shock absorber 30 is substantially symmetrical to a central axis C thereof, parallel to the panel module 10. Here, the shock absorber 30 comprises a flexible structure 301 including a first flexible component 3011 and a second flexible component 3012. In this embodiment, the first and second flexible components 3011 and 3012 are curved and firmly connected by the rivets 305, forming a space 301′ therebetween, as shown in FIGS. 3 and 4. When an external force F parallel to the central axis C is applied to the frame 20, as shown in FIG. 3, the first flexible component 3011, the second flexible component 3012 and the space 301′ of the shock absorber 30 are deformed to absorb shock and protect the panel module 10 from damage. In some embodiments, the first and second flexible components 3011 and 3012 may comprise metal or other flexible material, such as metal sheets. In some embodiments, the first and second flexible components 3011 and 3012 may also be connected by single rivet at each joint.

As shown in FIGS. 2-4, the shock absorber 30 further comprises a first member 302 fixed to the first flexible component 3011, a second member 304 fixed to the second flexible component 3012, and a resilient member 303 connecting the first and second members 302 and 304. The resilient member 303, such as a compression spring, is accommodated in the space 301′ and contacts the first and second flexible components 3011 and 3012. Specifically, a connection portion 3022 of the first member 302 and the second member 304 are received in both ends of the resilient member 303, as shown in FIG. 4. The resilient member 303 enhances shock absorption of the shock absorber 30 and prevents elastic fatigue of the first and second flexible components 3011 and 3012.

Referring to FIG. 2, the first member 302 is located on the central axis C and joined in a first opening 3011′ of the first flexible component 3011. As shown in FIG. 4, a joining portion 3021 of the first member 302 is fastened through the first opening 3011′ and projects from an outer surface of the first flexible component 3011. During assembly, the joining portion 3021 is joined in the recess 101 of the panel module 10, as shown in FIG. 1, to connect the panel module 10 and the shock absorber 30. In some embodiments, the first member 302 can be a screw, and the recess 101 can be a threaded hole corresponding thereto. In FIG. 4, the connection portion 3022 projects from an inner surface of the first flexible component 3011 and is received in an end of the resilient member 303, such that the first flexible component 3011 and the resilient member 303 are connected.

Referring to FIGS. 2-4, the second member 304 is located on the central axis C and projects from an inner surface of the second flexible component 3012. During assembly, the second member 304 is received in the other end of the resilient member 303, such that the second flexible component 3012 and the resilient member 303 are connected. As shown in FIGS. 1 and 3, the fastener S is fastened through the frame 20 and joined in a second opening 3012′ of the second flexible component 3012 along the central axis X. In some embodiments, the second member 304 and the second flexible component 3012 are monolithically formed in one piece, wherein the second member 304 has a threaded hole connecting the second opening 3012′ with the fastener S joined therein.

Flat displays are provided according to the embodiments. At least one shock absorber is disposed between the panel module and the frame, facilitating shock absorption and preventing damage from impact and external force.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. A flat display, comprising:
a frame;
a panel module disposed in the frame; and
a shock absorber disposed between the frame and the panel module, comprising a first flexible component, a second flexible component, and a space formed therebetween, wherein the first and second flexible components are curved and firmly connected to each other at both ends thereof, and when external force is exerted on the frame, the first flexible component, the second flexible component and the space are deformed to absorb shock and protect the panel module.

2. The flat display as claimed in claim 1, wherein the shock absorber further comprises a resilient element received in the space and connected to the first and second flexible components.

3. The flat display as claimed in claim 2, wherein the resilient element is a compression spring.

4. The flat display as claimed in claim 1, wherein the shock absorber further comprises a first member fixed to the first flexible component, wherein the first member comprises a joining portion projecting from an outer surface of the first flexible component and connecting the panel module.

5. The flat display as claimed in claim 4, wherein the first flexible component comprises a first opening with the joining portion fastened therethrough.

6. The flat display as claimed in claim 4, wherein the panel module comprises a recess with the joining portion joined therein.

7. The flat display as claimed in claim 4, wherein the first member further comprises a connection portion projecting from an inner surface of the first flexible component and received in the resilient element.

8. The flat display as claimed in claim 4, wherein the shock absorber further comprises a second member fixed to the second flexible component and received in the resilient element.

9. The flat display as claimed in claim 8, wherein the shock absorber is substantially symmetrical to a central axis with the first and second members located thereon.

10. The flat display as claimed in claim 9, wherein the external force and the panel module are substantially parallel to the central axis.

11. The flat display as claimed in claim 1, further comprising a fastener through the frame and connected to the shock absorber.

12. The flat display as claimed in claim 11, wherein the fastener is a screw.

13. The flat display as claimed in claim 1, further comprising a fastener through the frame, and the second flexible component comprises a second opening with the fastener joined therein.

14. The flat display as claimed in claim 1, wherein the first and second flexible components are connected by rivets.

15. The flat display as claimed in claim 1, wherein the flat display comprises a plurality of shock absorbers.

16. The flat display as claimed in claim 1, wherein the first and second flexible components comprise metal.

17. The flat display as claimed in claim 16, wherein the first and second flexible components are metal sheets.
